(19) United States
(12) Patent Application Publication
(10) Pub. No.: US 2008/0195696 A1
(43) Pub. Date: Aug. 14, 2008

(54) Method For Intercepting Http Redirection Requests, System And Server Device For Carrying Out Said Method

(76) Inventors: Anne Boutroux, Hermanville Sur Mer (FR); Nicolas Saillard, Fougeres (FR); Etienne Annic, Rambouillet (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/666,522

(22) PCT Filed: Oct. 25, 2005
(86) PCT No.: PCT/FR2005/050898

§ 371 Date: Sep. 10, 2007

(30) Foreign Application Priority Data
Oct. 27, 2004 (FR) 0411458

(51) Int. Cl. G06F 15/16

(52) U.S. Cl. 709/203

(57) ABSTRACT

A redirection request interception method includes: a step (E10) of receiving an HTTP response sent to a user station; a step (E30) of obtaining a redirection address contained in that response; a step (E40) of creating and a step (E50) of sending a substitution request to that redirection address; a step (E60) of receiving the response to that substitution request; and a step (E70) of transmitting that response to the user station.

The present invention relates generally to a method and a system for improving access to a service on an Internet-type network.

To be more precise, this invention aims to improve the redirection mechanism described in Request for Comments RFC 2616 of the Internet Engineering Task Force (IETF), which mechanism, as is known in the art, redirects a user seeking access to a first HTML page to another HTML page by including in the first page a “meta” containing the URL address of the second page, in the following manner:

<meta http-equiv=“refresh” content=“0; url=http://redirectionpage/”>.

This redirection mechanism is seriously flawed, especially if used in a mobile telecommunications network offering a limited bit rate, since the usable bit rate necessary for consulting the required pages is overloaded by the traffic caused by redirection.

Note that these round trips have a significant impact on traffic, a statistical study carried out on a business network indicating that redirection represents more than 10% of text/HTML-type requests.

The invention aims to remove this flaw by bypassing redirection requests sent to mobile equipments by the servers of the Internet network, which reduces the latency experienced by the user.

To this end, a first aspect of the invention provides to a server for modifying HTTP requests and responses which can be used in an Internet-type network, the server comprising:
means for receiving a redirection request contained in an HTTP response sent to a user station;
means for obtaining a redirection address contained in the HTTP response;
means for creating a substitution request from information relating to the user station;
means for sending the substitution request to the redirection address;
means for receiving a response to the substitution request; and
means for transmitting the response to the substitution request to the user station.

In the description below, for conciseness, the request and response modification server is referred to as the “modification server”.

According to the invention, the modification server receives the redirection request normally addressed to the user station and then accesses the content at the redirection address, only that content being sent to the user station.

Accordingly, if the user station is a mobile equipment, only the useful content, that is to say the content that the user is seeking, is conveyed over the mobile telecommunications network.

A preferred embodiment of the modification server according to the invention further comprises means for obtaining the information relating to the client station from a proxy server comprising a client adapted to implement said HTTP request and response modification protocol.

In this preferred embodiment, information relating to the client station is collected directly or indirectly by the proxy server, the modification server being advantageously dedicated to managing the request redirection service as such.

A second aspect of the invention is directed to a system for intercepting a redirection request contained in an HTTP response sent to a user station in an Internet-type network, this system including:
an HTTP request and modification server as referred to above; and
a proxy server comprising:
means for implementing the HTTP protocol; and
a client adapted to implement the HTTP request and response modification protocol and to send the redirection request to the modification server.

The proxy server preferably includes means for recording the subscription of the user station to the redirection request interception service and the proxy server client verifies if the user station has subscribed to that service before transmitting the redirection request to the modification server.

In a first embodiment, the means for recording the user's subscription are adapted to obtain information relating to that user directly, for example in the form of a subscription questionnaire.

In another embodiment, the proxy server obtains information relating to the user station by analyzing the HTTP traffic that passes through it.

A correlated third aspect of the invention is aimed at a method of intercepting a redirection request contained in an HTTP response sent to a user station in an Internet-type network, that method being adapted to be implemented by an HTTP request and response modification server and comprising:
a step of receiving the HTTP response;
a step of obtaining a redirection address contained in the HTTP response;
a step of creating a substitution request from information relating to the user station;
a step of sending the substitution request to the redirection address;
a step of receiving a response to the substitution request; and
a step of transmitting the response to the substitution request to the user station.

The particular advantages of the interception method being identical to those of the modification server introduced above, they are not repeated here.

Other aspects and advantages of the present invention become more clearly apparent on reading the following description of particular embodiments given by way of non-limiting example only and with reference to the appended drawings, in which:

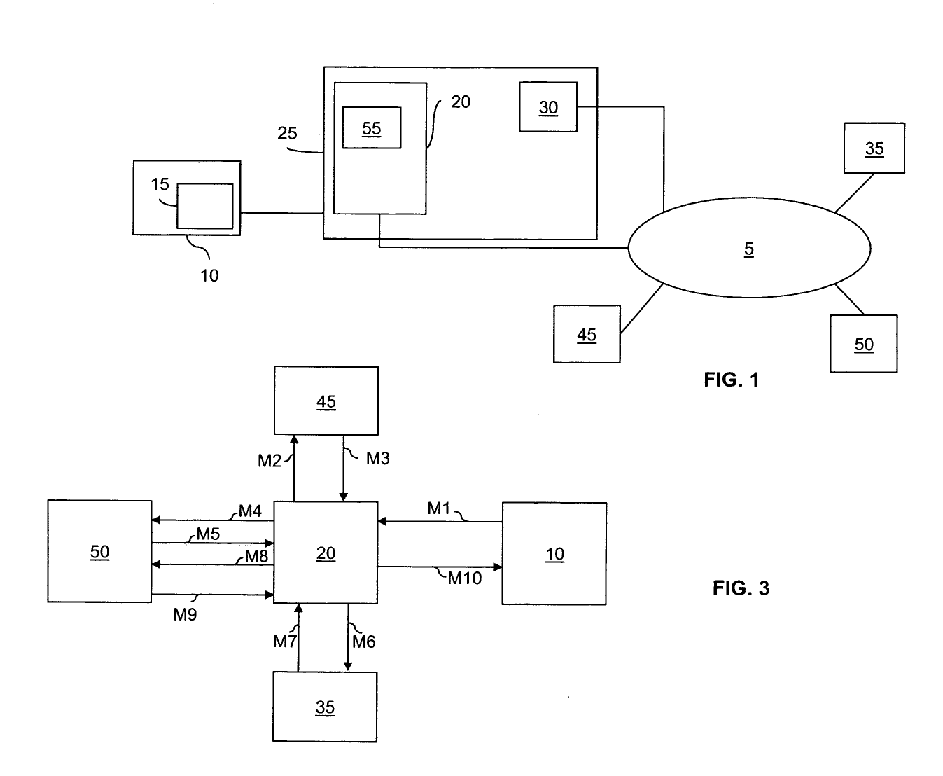

FIG. 1 is a diagram representing a preferred embodiment of a redirection request interception system according to a preferred embodiment of the invention;

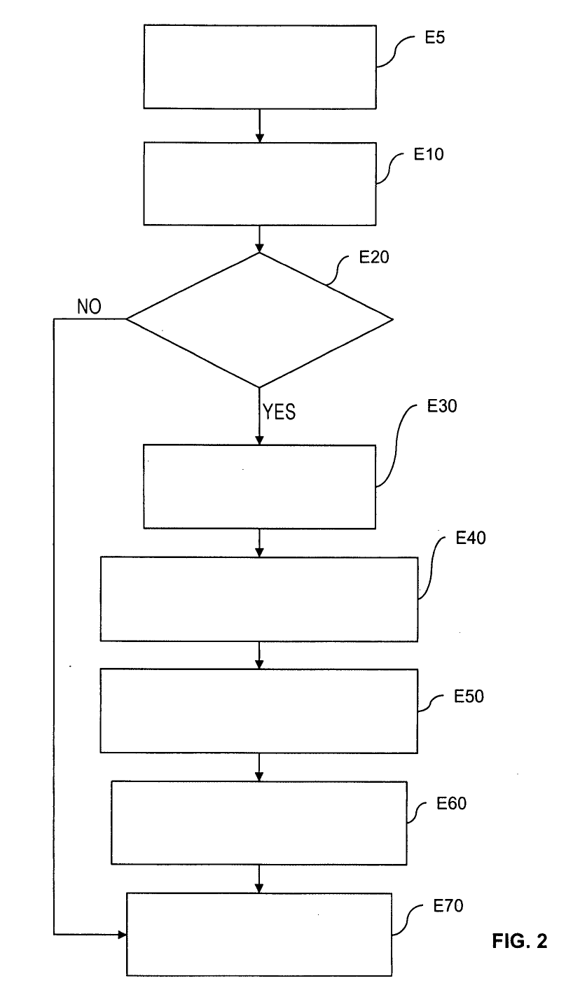

FIG. 2 is a flowchart showing the main steps of a redirection request interception method used in the FIG. 1 system; and

FIG. 3 is a diagram representing the flow of information between the various equipments of the FIG. 1 interception system.

FIG. 1 represents a preferred embodiment of a system for intercepting redirection requests in an Internet-type network 5.

That system includes a user station 10 equipped with an Internet browser 15 and connected to the Internet-type network 5 via a proxy server 20 adapted to implement the HyperText Transfer Protocol (HTTP).

In the preferred embodiment described here, the proxy server 20 is hosted by a service provider 25 to which the user station 10 must be connected in order to access the network 5.

The service provider 25 also includes an access control server 30 for authenticating the user of the station 10, for example on the basis of an identifier (login) and a password, and supplying an Internet Protocol (IP) address to the station 10 so that the station can navigate the Internet-type network 5.

Once the IP address has been delivered, all HTTP requests for access to the network 5 and responses sent and received by the user station 10 pass in transit through the proxy server 20.

In the preferred embodiment described here, the proxy server 20 includes means for recording the subscription of the user of the user station 10 to a redirection request interception service.

When this subscription is taken out, the proxy server 20 collects and stores information relating to the user station 10 (IP address, session cookie, etc.).

Alternatively, the proxy server 20 adapted to implement the HTTP can directly obtain personal information relating to the user station 10 by analyzing the HTTP traffic.

The access system also comprises a service provider 45 connected to the network 5 to provide services to the user of the station 10 in response to an access request M1 forwarded by the proxy server 20 in the form of a request M2.

It is assumed below that the service provider 45 responds to the request M2 by sending the user station 10 an HTTP response M3 including a redirection request.

As is known in the art, this HTTP response M3 includes the Internet Protocol (IP) address of the user station 10.

The system according to the invention also comprises a “request modification server” 50 connected to the Internet-type network 5 and adapted to implement a protocol enabling modification of HTTP requests and responses.

In the preferred embodiment described here, the request modification server 50 includes means for obtaining information relating to the user station 10 from the proxy server 20, that information having been obtained by the proxy server 20 when the user of that station took out the subscription to the redirection request interception service, for example.

In the preferred embodiment described here, this server 50 is an Internet Content Adaptation Protocol (iCAP) server adapted to implement the Internet Content Adaptation Protocol.

According to the invention, the proxy server 20 comprises a client 55 adapted to implement the same protocol as the request modification server 50, namely the Internet Content Adaptation Protocol here.

In a first embodiment, the iCAP client 55 of the proxy server 20 is configured to send the iCAP server 50 only HTTP responses M3 including redirection requests addressed to a user who subscribes to the redirection request interception service.

Accordingly, in this first embodiment, when the proxy server 20 sees an HTTP request M3 including a redirection request, it intercepts that response and sends it to the iCAP server 50 in the form of iCAP request M4, using the Internet Content Adaptation Protocol.

In a second embodiment, the iCAP client 55 of the proxy server 20 sends the iCAP server 50 all HTTP responses addressed to the user station 10.

In this second embodiment, the iCAP server 50 includes means for sending the HTTP response M3 received from the proxy server 20 directly to the user station 10 if that response M3 does not include a redirection request.

It is assumed below that the iCAP server 50 has received the HTTP response M3 in the form of the iCAP request M4, this HTTP response M3 including the redirection request and the IP address of the user station 10.

According to the invention, the iCAP server 50 is adapted to obtain the redirection URL address from this HTTP response M3.

According to the invention, the iCAP server 50 includes means for creating an HTTP substitution request M5 from information relating to the user station 10 (IP address, session cookies, etc.), so that the content of this HTTP substitution request M5 is identical to the content of the HTTP request that the Internet browser 15 of the user station 10 would have created in response to the HTTP response M3 sent by the service provider 45.

The iCAP server 50 includes means for sending the HTTP substitution request M5 to the HTTP server 35 whose address on the Internet-type network 5 is the redirection URL address obtained in the HTTP response M3.

In the embodiment described here, this HTTP substitution request M5 is relayed by the proxy server 20 in the form of an HTTP request M6.

The iCAP server 50 includes means for receiving the HTTP response M7 to the HTTP substitution request M5, that response being relayed by the proxy server 20 in the form of an HTTP response M8 in the preferred embodiment described here.

According to the invention, the iCAP server 50 comprises sending means for sending this HTTP response M8 to the user station 10 (in this instance the HTML page at the Internet address/redirectionpage/) in the form of an HTTP response M9 that is relayed by the proxy server 20 in the form of an HTTP response M10.

The flow of information between the equipments of the interception system from FIG. 1, to be more precise the main steps of the interception method implemented by the iCAP server 50, are described next with reference to FIGS. 2 and 3.

It is assumed first of all that the user of the user station 10 subscribes to the redirection request interception service and that the iCAP server 50 has obtained the user's personal information (IP address, session cookie, etc.) from the proxy server 20 during a preliminary step E5.

It is also assumed that the user of the station 10 wishes to access a service provided by the service provider 45 and that an access request M1 to the service provider 45 has been relayed by the proxy server 20 and then sent to the service provider 45 in the form of a request M2.

It is finally assumed that the service provider 45 has responded to the request M2 with an HTTP response M3 to the user station 10 including a redirection request and that this HTTP response M3 has been intercepted by the proxy server 20 and transmitted to the iCAP server 50 in the form of an iCAP request M4.

During a first step E10, the iCAP server 50 receives the HTTP response M3 in the form of the iCAP request M4.

This reception step E10 is followed by a test E20 during which the iCAP server 50 looks to see if the HTTP response M3 contains a redirection request.

Otherwise, the result of the test E20 is negative and this test is followed by a step E70 during which the iCAP server 50 sends the HTTP response M3 to the user station 10.

In contrast, if the HTTP response M3 does include a redirection URL address, the result of the test E20 is positive.

This test is then followed by a step E30 during which the iCAP server 50 obtains the redirection URL address in the HTTP response M3.

This step E30 is then followed by a step E40 during which the iCAP server 50 creates a substitution request M5 from the personal information (IP address, session cookie, etc.) obtained by the iCAP server 50 beforehand, during the preliminary step E5.

As described above, this HTTP substitution request M5 is similar to an HTTP request that the Internet browser 15 of the user station 10 would have created in response to the HTTP response M3 sent by the service provider 45.

This step E40 is followed by a step E50 of sending the substitution request M5 to the redirection URL address.

In the embodiment described here, this HTTP substitution request M5 is relayed by the proxy server 20 in the form of an HTTP request M6.

The step E50 of sending the substitution request M5 is followed by a step E60 of receiving a response M7 to the substitution request M5.

In the embodiment described here, this HTTP response M7 is relayed by the proxy server 20 in the form of an HTTP response M8. This is in fact the HTML page situated at the URL address relayed by the proxy server 20.

The step E60 of receiving the HTTP response M8 is followed by the step E70 of transmitting that response to the user station 10 in the form of an HTTP response M9 relayed by the proxy server 20 in the form of an HTTP response M10.

1. A server for modifying HTTP requests and responses which can be used in an Internet-type network (5), the server being characterized in that it comprises:
means for receiving a redirection request contained in an HTTP response (M3) sent to a user station (10);
means for obtaining a redirection address (URL) contained in said HTTP response (M3);
means for creating a substitution request (M5) from information relating to said user station (10);
means for sending said substitution request (M5) to said redirection address (URL);
means for receiving a response (M8) to said substitution request (M5); and
means for transmitting said response (M8) to the substitution request (M5) to said user station (10).

2. An HTTP request and response modification server according to claim 1, characterized in that it further comprises means for obtaining said information relating to the client station (10) from a proxy server (20) comprising a client (55) adapted to implement said HTTP request and response modification protocol.

3. A system for intercepting a redirection request contained in an HTTP response sent to a user station (10) in an Internet-type network (5), the system being characterized in that it includes:
an HTTP request and modification server (50) according to claim 1; and
a proxy server (20) comprising:
means for implementing the HTTP protocol; and
a client (55) adapted to implement said HTTP request and response modification protocol and to send said redirection request to said HTTP request and response modification server.

4. An interception system according to claim 3, characterized in that:
said proxy server (20) includes means for recording the subscription of said user station (10) to a redirection request interception service; and
said client (55) is adapted to verify if said user station (10) has subscribed to said service before transmitting said redirection request to said HTTP request and response modification server (50).

5. An interception system according to claim 4, characterized in that said subscription recording means are adapted to obtain the information relating to said user station (10).

6. An interception system according to claim 4, characterized in that said means of the proxy server (20) for implementing the HTTP protocol are adapted to obtain the information relating to said user station (10).

7. A method of intercepting a redirection request contained in an HTTP response (M3) sent to a user station (10) in an Internet-type network (5), that method being adapted to be implemented by an HTTP request and response modification server (50) and comprising:
a step (E10) of receiving said HTTP response;
a step (E30) of obtaining a redirection address (URL) contained in said HTTP response (M3);
a step (E40) of creating a substitution request (M5) from information relating to said user station (10);
a step (E50) of sending said substitution request (M5) to said redirection address (URL);
a step (E60) of receiving a response (M8) to said substitution request (M5); and
a step (E70) of transmitting said response (M8) to the substitution request (M5) to said user station (10).

8. An interception system according to claim 7, characterized in that it comprises a preliminary step (ES) of obtaining said information relating to the client station (10) from a proxy server (20) including a client (55) adapted to implement said HTTP request and response modification protocol.

9. An interception system according to claim 3, characterized in that said means of the proxy server (20) for implementing the HTTP protocol are adapted to obtain the information relating to said user station (10).
